(19) United States
(12) Patent Application Publication
(10) Pub. No.: US 2025/0314400 A1
(43) Pub. Date: Oct. 9, 2025

(54) HEAT EXTRACTION SYSTEM AND METHOD FOR EXTREME ENVIRONMENTS

(71) Applicant: CGG SERVICES SAS, Massy Cedex (FR)

(72) Inventors: Mariane PETER-BORIE, Saint Nexans (FR); Robert CROSSLEY, Conwy (GB); Elisha DRUMM, Bridge of Weir (GB)

(21) Appl. No.: 18/726,510

(22) PCT Filed: Dec. 22, 2023
(86) PCT No.: PCT/EP2023/087738

§ 371 Date: Jul. 3, 2024

(30) Foreign Application Priority Data
Aug. 1, 2023 (FR) 2308348

(51) Int. Cl. F24T 10/17

(52) U.S. Cl. CPC F24T 10/17

(57) ABSTRACT

A tool for extracting heat from a reservoir includes a shoe made of a material that withstands temperatures larger than 500° C., an outer pipe attached to the shoe, an inner pipe located within the outer pipe and forming an annulus with the outer pipe, the inner pipe having a bore, and a flexible connection configured to connect the outer pipe to the shoe so that the outer pipe is allowed to extend and contract without leaking a fluid inside the annulus. The inner pipe and the outer pipe are configured to form an uninterrupted loop path for the fluid, between a top of the annulus and a top of the bore while also allowing the fluid to directly contact the shoe.

### TECHNICAL FIELD

Embodiments of the subject matter disclosed herein generally relate to a system and method for extracting heat from an environment having a high temperature, and more particularly, to an underground co-axial tool terminated with a closed shoe, where only the shoe is configured to enter the high temperature environment, and the tool is configured to circulate a fluid past the shoe, to harvest the heat received by the shoe from the environment, and to transfer the heat to the surface.

### DISCUSSION OF THE BACKGROUND

Exploitation of underground superhot reservoirs (SHR) is a promising solution to produce a large amount of energy. These underground superhot reservoirs can be natural, or man-made on purpose (such as underground coal gasification), or by accident (such as peat or coal fires). No matter the origin of the SHRs, it is desired to extract their generated energy with minimum pollution.

Natural SHR are created by proximal magma, for example, where temperatures over 900° C. are reached. In this regard, a well in Iceland was accidently drilled into magma. This well would have been able to produce a larger amount of energy almost for free, e.g., 36 MWe, in addition to the installed electrical capacity of 60 MWe from the 33 wells drilled for the local geothermal power plant [1].

SHR can also be intentionally made (e.g., man-made), as in the framework of ultra-high temperature Underground Thermal Energy Storage (UHT-UTES). For example, concentrated solar power (CSP) systems can achieve high temperatures over 500° C. and up to 2,000° C. during the day by using a parabolic trough or other devices, but not necessarily when the energy demand is high. UTES is then a solution for storing a high temperature fluid, and extracting the energy associated with fluid when the CSP systems are not capable of generating enough energy. Storage solutions in the natural ground have been investigated and various studies consider temperatures up to 650° C. for storing the heated fluid. Other Ultra-high temperature energy sources can also be considered, such as nuclear plants.

SHR can be created by processes with another purpose, such as Underground Coal Gasification (UCG), that aims to produce syngas from an underground coal combustion process with temperatures between 600° C. and 1,000° C. [2-4].

However, recovering heat from SHR is challenging, due to extreme conditions (temperature, corrosion, and pressure) under which the materials and systems are used. In this regard, the well discussed above, which accidentally drilled into 900° C. magma, was constructed with carbon steel with API grades K55 and T95, which are traditionally used for the geothermal wells. The casing in this case rapidly collapsed, ending the exploitation of the large amount of energy available there. After the well was terminated and then shut-in, the well was logged with a video camera. Severe corrosion as well as tensile ruptures were observed, later confirmed by the analysis of the 8-m retrieved from the uppermost part of well.

From these experiences, it is noted that conventional wells and tools, even when made with the more resistant steel grades, are not suitable for a long-term extraction of the heat in SHR. Several disadvantages of these wells and tools include:

The cylindrical shape of the well casing is prone to bulking and collapse under thermo-mechanical stresses (thermal cycling is an aggravating factor),

When the geothermal brine is used as a working fluid, the risk of corrosion of the steel due to the chemical composition of the brine is worsened by the ultra-high temperature, and

The potential damaging of the surrounding rock mass (fracking, cavity creation and spalling in the case of UCG) increases with the temperature due to the additional thermal stress.

In addition, the annular cement used around the well has a significant role in the well structural integrity and durability. The cement must provide mechanical support for the steel casing, shields the casing from corrosive formation fluids, and the multilayer composed by several casings and cement layers in between the casings, must ensure brine leak prevention from the annulus to the different strata crossed by the well. Thermal stress and associated damaging of the cement jeopardize this role.

Thus, there is a need for a new system/tool that is capable of extracting the heat from the SHR while being able to withstand the harsh conditions existing in the SHR.

### SUMMARY OF THE INVENTION

According to an embodiment, there is a method for extracting heat from an underground location with a co-axial tool that includes a shoe made of a material resistant to heat. The method includes a step of placing the shoe of the co-axial tool into the underground location while ensuring that other parts of the tool are not in direct contact with the underground location. The method further includes a step of pumping a fluid into the tool, either through a bore of an inner pipe, to the shoe, and then back to the surface, through an annulus formed by the inner pipe and an outer pipe, or through the annulus to the shoe and then back to the surface through the bore. The fluid exchanges heat with the shoe, which is placed in the hot underground location.

According to another embodiment, there is a tool for extracting heat from a reservoir, and the tool includes a shoe made of a material that withstands temperatures larger than 500° C., an outer pipe attached to the shoe, an inner pipe located within the outer pipe and forming an annulus with the outer pipe, the inner pipe having a bore, and a flexible connection configured to connect the outer pipe to the shoe so that the outer pipe is allowed to extend and contract without leaking a fluid inside the annulus. The inner pipe and the outer pipe are configured to form an uninterrupted loop path for the fluid, between a top of the annulus and a top of the bore while also allowing the fluid to directly contact the shoe.

According to yet another embodiment, there is a heat extraction system for extracting heat from a reservoir, and the heat extraction system includes a casing element configured to be lowered into a well or driven into the ground, and a tool configured to be attached to a distal end of the casing element. The tool includes a shoe made of a material that withstands temperatures larger than 500° C., an outer pipe attached to the shoe, an inner pipe concentrically located within the outer pipe and forming an annulus with the outer pipe, the inner pipe having a bore, and a flexible connection configured to connect the outer pipe to the shoe so that the outer pipe is allowed to extend and contract without leaking a fluid inside the annulus. The inner pipe and the outer pipe are configured to form an uninterrupted loop path for the fluid, between a top of the annulus and a top of the bore while also allowing the fluid to directly contact the shoe.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a heat extraction tool having an end shoe for protecting inner and outer pipes from direct exposure to the extreme conditions in the explored reservoir;

FIGS. 2A and 2B illustrate a flexible connection that allows the inner and outer pipes to fluidly connect to the end shoe without leaks while accounting for thermal expansion;

FIG. 3A is a schematic diagram of the end shoe of the heat extraction tool having an integral strainer element and FIG. 3B is a schematic diagram of the end shoe without the strainer element;

FIG. 4 is a table presenting various materials that may be used for making the shoe so that the shoe can withstand a high temperature;

FIG. 5 is a schematic diagram of another heat extraction tool having an end shoe for thermally protecting inner and outer pipes;

FIG. 6. is a schematic diagram of yet another heat extraction tool having an end shoe for thermally protecting inner and outer pipes;

FIG. 7 is a schematic diagram of still another heat extraction tool having an end shoe for thermally protecting inner and outer pipes;

FIGS. 8A to 8C illustrate various shapes of the end shoe;

FIG. 9A illustrates the drilling of a well for the heat extraction tool, FIG. 9B illustrates the placement of the heat extraction tool into the well so that only the end shoe enters the high temperature reservoir, and FIG. 9C illustrate the closing of the well after the heat has been extracted and the heat extraction tool has been removed; and

FIG. 10 is a flow chart of a method for extracting heat from a reservoir with the heat extraction tool.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a co-axial tool provided with an end helix shoe for entering the SHR. However, the embodiments to be discussed next are not limited to the helix shoe, but the co-axial tool may be provided with differently shaped end shoes. Further, the embodiments discussed next are not limited to a co-axial tool as the tool may use non-co-axial pipes.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel co-axial tool for heat extraction includes an inner pipe and an outer pipe [5], which are concentrically located. In one embodiment, the longitudinal axis of the two pipes may be offset from each other. Each of the inner and outer pipes may be attached, directly or indirectly, to a corresponding portion of an end shoe. The shoe is configured to enter the reservoir with the extreme conditions (e.g., high temperature, high pressure, high corrosion) while the inner and outer pipes are protected from these conditions, i.e., they are configured to stay outside the reservoir. The inner and outer pipes are configured to allow a fluid to circulate from the surface to the end shoe and then back to the surface through different paths, for example, first, downwards toward the end shoe through an annulus formed between the two pipes and then up toward the surface through a bore of the inner pipe. Note that the fluid may alternatively flow first through the bore of the inner pipe and then up towards the surface through the annulus of the two pipes. The fluid flow directly contacts a portion of the end shoe to receive the reservoir heat.

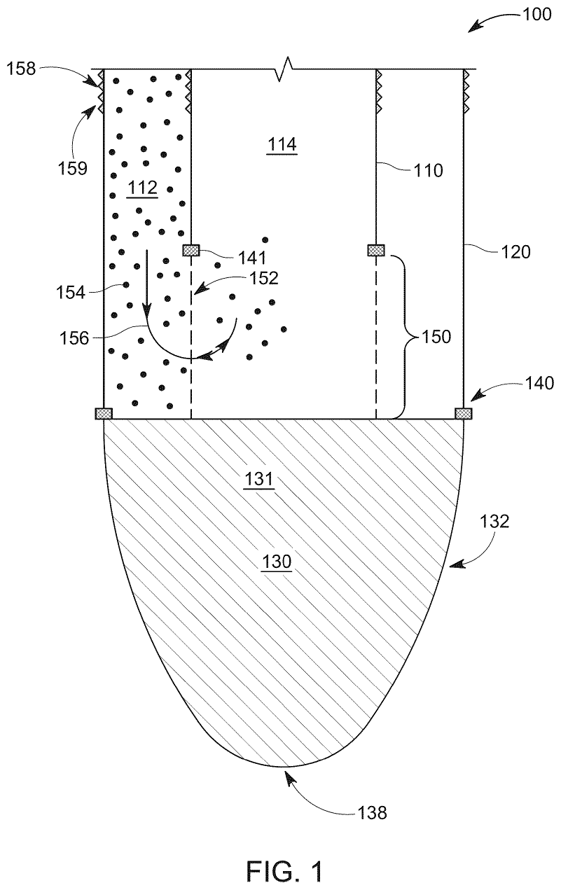

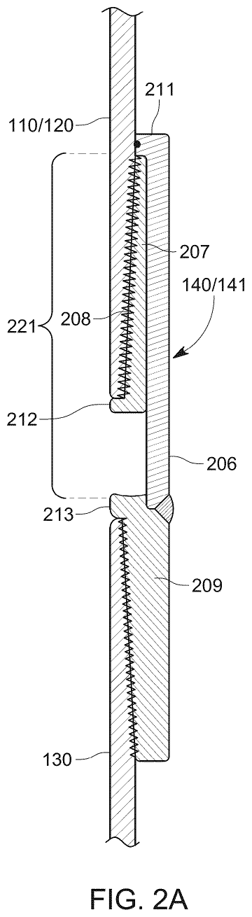

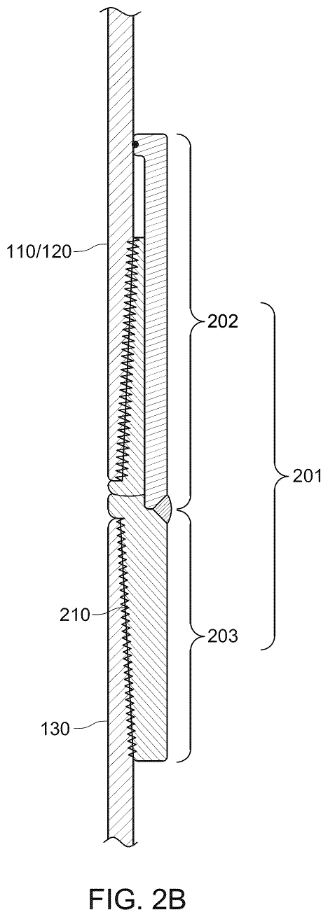

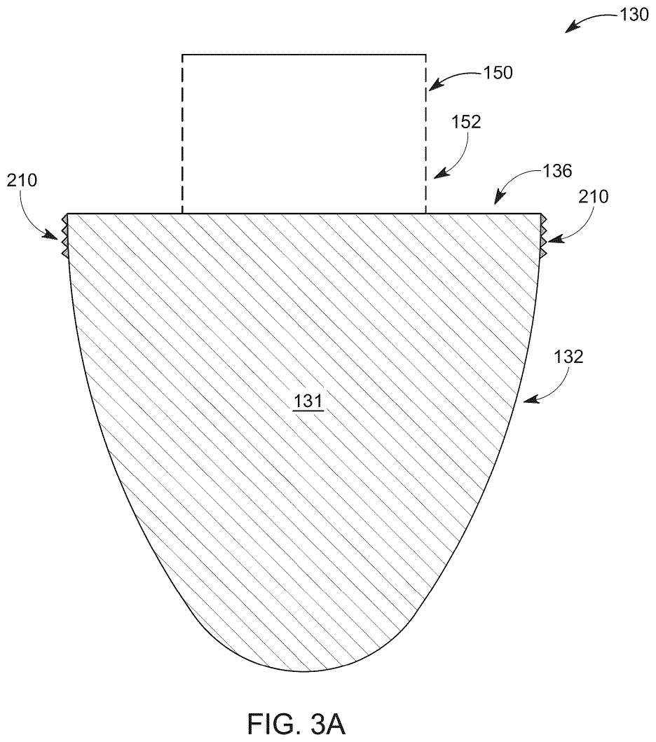

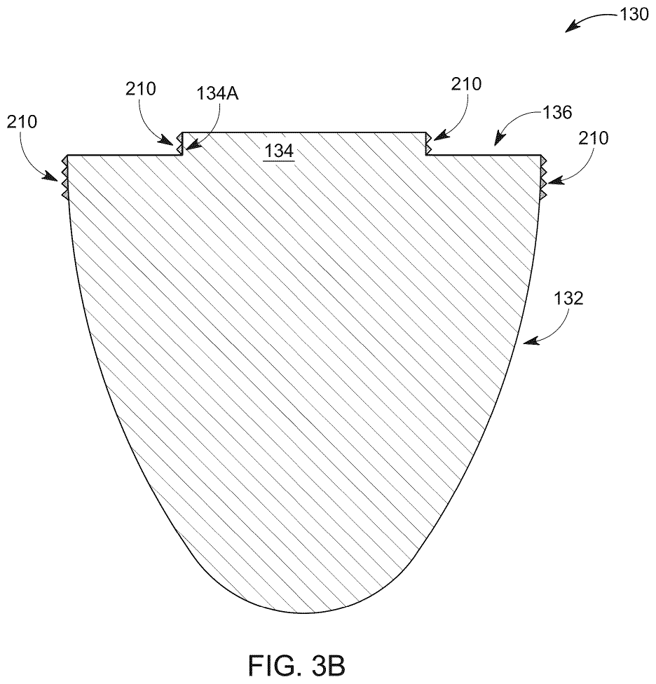

More specifically, as shown in FIG. 1, the novel tool 100 (also called herein “well tool” or “co-axial tool” or “heat extraction tool”) includes an inner pipe 110, an outer pipe 120, concentric to the inner pipe 110, and an end shoe 130. The outer pipe 120 is connected to the shoe 130 through a first flexible coupling 140 while the inner pipe 110 is connected to the shoe 130 through a second flexible coupling 141. A flexible coupling 140 or 141 is any coupling between two different elements that allow one or both elements to expand due to thermal reasons while maintaining the integrity of the fluid flow through the coupling, i.e., not leaking the fluid. An example of such flexible coupling was introduced in [6] and [7], and is illustrated in FIGS. 2A and 2B (which correspond to FIGS. 3A and 3B of [6]). The flexible coupling 140/141 allows the two connected elements (for example, 110 and 130 or 120 and 130) to achieve a fluid connection that is expandable when the temperature increases, without bucking or leaking the fluid inside. More specifically, FIGS. 2A and 2B show the flexible coupling 140/141 having a hollow tubular main body 201 having first tubular sleeve opening 202 being attached to the outer casing 120 and a second tubular sleeve opening 203 being attached to a rim or shoulder of the end shoe 130. The figures outline how the connector can take up thermal expansion due to temperature change when high temperature media starts flowing through the tool 100 and contraction when the well needs to be cooled down.

More specifically, an axially extending inwardly facing circumferential spacing 221 is created by an inwardly extending upper rim 211 in proximity to the first tubular sleeve opening 202 and an inwardly extending central rim 213. An inner tubular member 207 is provided extending radially within the spacing 221. The inner tubular member has a first circumferential engaging zone for engaging a mating engaging zone of an end of the external pipe 120 and a second circumferential engaging zone in proximity to the second tubular sleeve opening 203, for engaging a mating engaging zone of an end of the shoe 130. The figures show how the inner tubular member 207 is shorter in the axial direction than the inwardly facing circumferential spacing 221 and is therefore reversibly and slidable within the inwardly facing circumferential spacing 221, between the inwardly extending upper rim 211 and the inwardly extending central rim 213. The inner tubular member 207 can slide freely in an axial direction within the spacing 221.

The figures further show that the outer pipe 120 has circumferential attaching zone 208 for attaching to the connector 140. In one embodiment, the attaching zone 208 includes threads. The lower tubular sleeve opening 203 includes an outer support member 209 which has a circumferential attaching zone 210 (for example, threads) for attaching the shoe 130 to the connector 140. The outer support member 206 of the upper tubular sleeve opening 202 has an inwardly extending upper rim 211 extending inwardly the equivalent to the thickness of the upper opening of the inner tubular member 207. Additionally, the inner tubular member 207 of the upper tubular sleeve opening 202 has an inwardly extending lower rim 212 extending inwardly the equivalent to the thickness of the lower opening of the outer pipe 120. Other types of flexible couplings 140 may be used. While FIGS. 2A and 2B describe a possible flexible connection between the outer pipe 120 and the shoe 130, the same flexible connection may be achieved between the inner pipe 110 and the shoe 130.

Note that for achieving the connection with the outer pipe 120, in one embodiment, the shoe 130 has threads 210 on an external surface 132, next to the top surface 136, as shown in FIGS. 3A and 3B. For achieving the connection with the inner pipe 110, in the embodiment of FIG. 3A, the shoe 130 also includes a strainer element 150, which is made integrally with the body 131 of the shoe. The strainer element 150 is shaped as a sleeve with an internal bore, and the lateral walls of the sleeve have plural holes 152. Note that a diameter of the strainer element is smaller than an external diameter of the body 131 at the top surface 136, to account for the annulus 112. For achieving the connection with the inner pipe in the embodiment of FIG. 3B, shoe 130 has a shoulder 134, which is raised from the top surface 136 of the shoe, and the threads 210 are formed on the side surface 134A of the shoulder 134 for directly engaging with the inner pipe. Those skilled in the art would understand that this implementation is one of the multiple possible implementations for the flexible coupling 140.

Returning to FIG. 1, the inner pipe 110 may be connected with yet another flexible connection 141 to the strainer element 150, when present. As discussed later, there are embodiments for which the strainer element 150 is omitted. The strainer element 150 may be a pipe having the same internal and/or external diameter as the inner pipe 110 and also a plurality of holes 152 for allowing a fluid 154 to leave an annulus 112, formed by the external surface of the inner pipe 110 and the inner surface of the outer pipe 120, and enter the bore 114 of the inner pipe 110. In this way, the fluid 154 may be pumped from the surface into the annulus 112, allowed to directly contact with the shoe 130, and then return to the surface through the bore 114 while caring the heat transferred from the shoe. Thus, a loop or path 156 is formed from the top of the annulus 112, to the shoe 130 and then to the top of the bore 114. In one application, the direction of the path 156 may be reversed, as schematically illustrated in the figure, i.e., the fluid enters first the bore 114, passes through the holes 152, and then enters the annulus 112 before reaching back the surface. Note that a top 158 of the tool 100 corresponds to the part of the tool that is configured to be attached to a casing element before being lowered into the well or driven into the ground. This means that the top part 158 of the tool 100 may have threads 159 for being attached to the casing element. Thus, the inner pipe 110 and the outer pipe 120 are configured to form an uninterrupted loop path 156 for the fluid 154, between a top of the annulus 112 and a top of the bore 114 while also allowing the fluid 154 to directly contact the shoe 130.

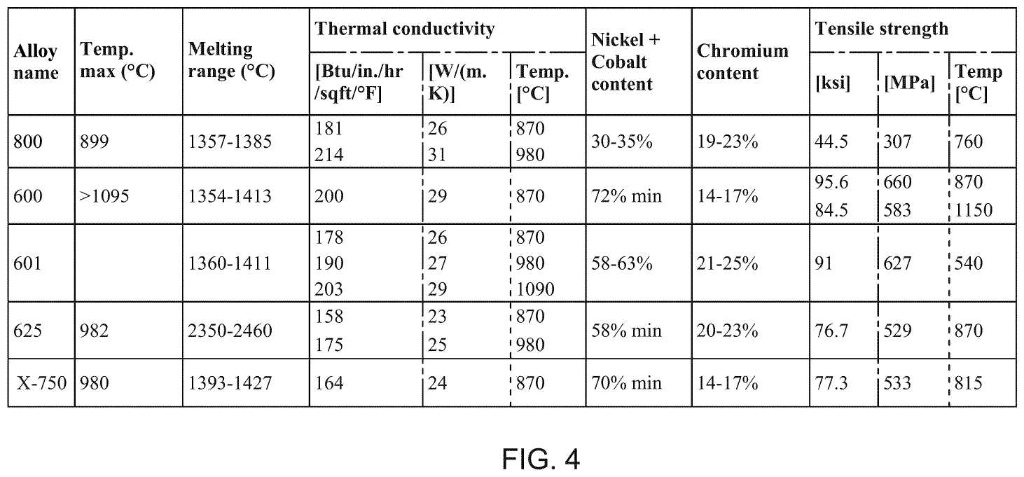

In the embodiment shown in FIG. 1, the shoe is made to be solid, i.e., its body 131 has no holes or channels except for the strainer element 150, which has the holes 152. It can be made of a single piece of material, i.e., the body 131 and strainer element 150 are integrally formed. The shoe (which is understood to be the body and the strainer element, when present) is also made of a metal or alloy that can withstand high temperatures (e.g., between 500 and 1200° C.) and/or high pressures, for example, up to 20 MPa. In one application, the shoe is made of tungsten or titanium. In another application, for which the price of the shoe is important to be as low as possible, an alloy with high qualities may be used. For example, stainless steels are the first to be considered, as they offer a good balance between the price and the resistance to extreme environments, in particular alloys usually used for thermal reactors and for combustion chambers, which have a higher tensile strength at high temperature. Some examples of these alloys are illustrated in the table of FIG. 4. Alloys including chrome, aluminium, and titanium offer good resistance to extreme conditions (high temperature deformation and corrosion mechanism). Note that as the alloy grade increases, its cost increases.

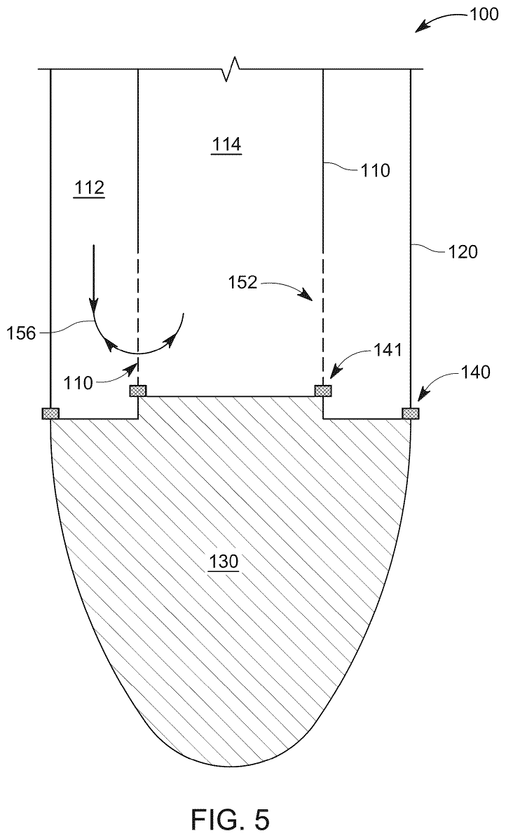

In another embodiment, as illustrated in FIG. 5, the strainer element 150 may be omitted (i.e., the configuration of the shoe 130 shown in FIG. 3B is used) and the holes 152 may be made directly into the lower part of the inner pipe 110. For this case, the flexible couplings 141 between the inner pipe and the strainer element are also not present as the inner pipe couples directly to the shoulder 134 of the shoe 130, with the flexible couplings 141 shown in the figure.

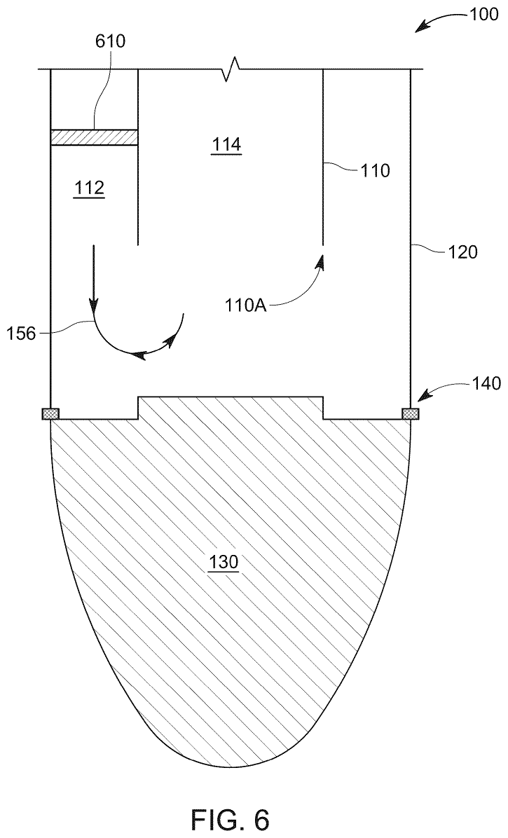

In yet another embodiment, as illustrated in FIG. 6, the inner pipe 110 is fixedly attached to the outer pipe 120 through one or more lugs 610. For this case, the lower end 110A of the inner pipe 110 is located above from the shoe 130, so that there is a free path 156 for the fluid 154 from the annulus 112 to the bore 114. In other words, there are no strainer element 150 and no holes 152 associated with the shoe 130 or the inner pipe 110 in this embodiment. The lugs 610 may also be used in the previous embodiments, i.e., to fix the inner pipe relative to the outer pipe.

However, in the previous embodiments, it is also possible that the inner pipe is independent of the outer pipe, i.e., they do not touch each other through any component, except for the strainer element and/or the shoe.

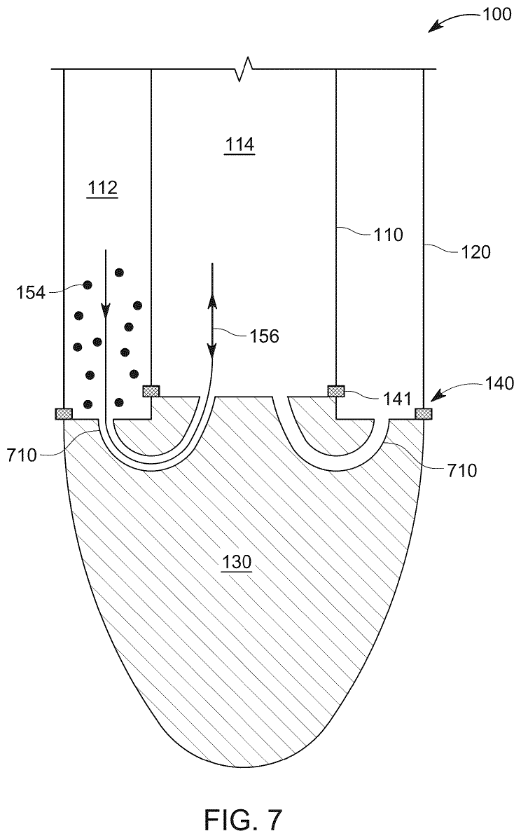

In still another embodiment, as illustrated in FIG. 7, the inner pipe 110 directly connects to the shoe 130, for example, through the flexible couplings 141, and no holes 152 are present in the inner pipe and no strainer element. For this embodiment, the configuration of the shoe 130 shown in FIG. 3B is used. Thus, for this embodiment, there is no direct fluid flow from the annulus 112 to the bore 114. For this case, there are plural channels 710 formed through the body of the shoe 130, that fluidly connect the annulus 112 to the bore 114, so that the fluid flux 154 still passes from the annulus to the bore, but through the body of the shoe. For this situation, the fluid is expected to remove more heat from the body of the shoe as the fluid effectively enters inside the shoe. While all the above embodiments show a flexible connection 140/141 between the inner and outer pipes and the end shoe, one skilled in the art would understand that nonflexible connection still may be used, even if there are fluid leaks. Note that for all the above embodiments, the shoe includes only a solid body with no other component, i.e., no through holes, channels, valves, etc. into the body 131, only the embodiment of FIG. 7 presents an additional structure, i.e., the channels 710.

With regard to the shape of the shoe 130, the previous embodiments illustrated it as being shaped like a bullet, for example, a largest external diameter matching the external diameter of the outer pipe and then the body having a vertex 138, as shown in FIG. 1. A length of the body (i.e., from the shoulder 134 to the vertex 138) may be selected depending on the width of the SHR to be explored. In one application, for the embodiment shown in FIG. 1, a length of the strainer element 150 is selected to depend on the diameter of the well in which the tool 100 is placed.

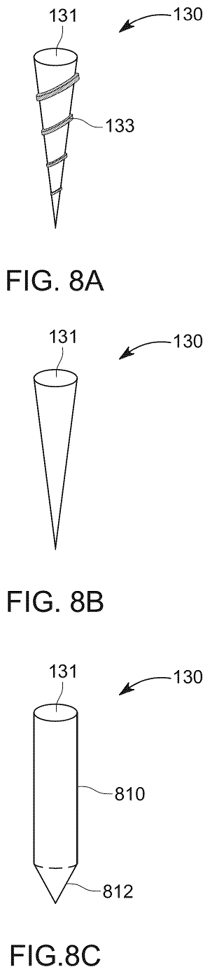

In one application, as shown in FIG. 8A (note that FIGS. 8A to 8C omit the strainer element for simplicity), the body 131 of the shoe 130 has a helix 133 extending along a length of the shoe. The helix may be added or formed into body 131 for promoting the advance of the shoe into the underground when a well is not previously drilled for lowering the tool 100. Note that the tool 100 may be lowered into a pre-drilled well or may be driven into the ground, if the underground is soft. FIG. 8B shows another embodiment in which the shape of shoe 130 is a flat cone. FIG. 8C shows yet another embodiment in which the shape of the shoe 130 is cylindrical 810 and ends with a pointed shape 812, for example, a cone. Those skilled in the art would understand that other shapes may be used.

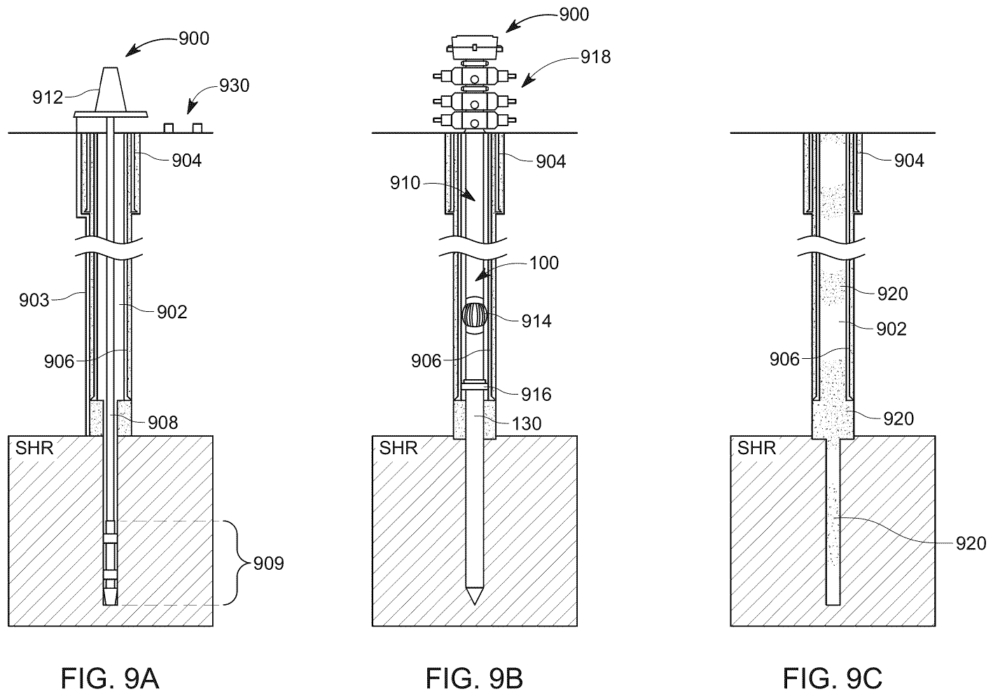

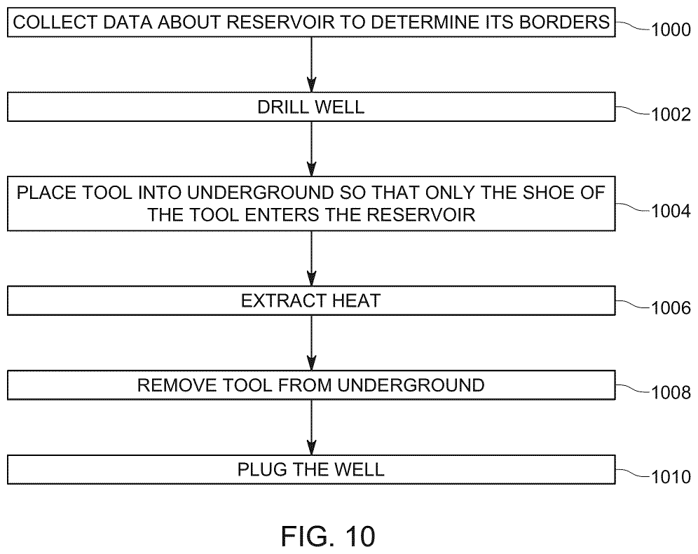

When the tool 100 is desired to be used (as illustrated in FIGS. 9A to 9C), various data (e.g., seismic survey, or information acquired while drilling the well, etc.) is collected in step 1000 (see flow chart of FIG. 10) before lowering (or driving) the tool into the ground. Based on this information, an upper border of the SHR is determined. In step 1002, a well 902 is drilled to reach the top of the SHR, as shown in FIG. 9A, and then, in step 1004, the tool 100 is lowered (or driven if no well is pre-drilled) into the well 902 until the shoe 130 directly contacts the SHR. In this embodiment, the shoe alone is directly in contact with the SHR, but not the inner and outer pipes, as illustrated in FIG. 9B. This makes the system 900 more resilient to potential damage due to the ultra-high temperature and to corrosion processes occurring in high temperature fluids. The shoe 130 is designed to resist thermo-mechanical strains due to thermal stress, ground movements during the heat extraction process. As discussed above, the shoe may be made of alloys that are resistant to high temperature (up to 1,000° C.), corrosive environments, thermal stress, burst strength, and with a sufficient thermal conductivity at the relevant temperatures. At very high temperatures, the thermal stability is the first factor considered, as this may set limits to a particular type of alloy from the standpoint of softening or embrittlement, and changes in the thermal properties such thermal conductivity with temperature variation. Note that the shoe is allowed to accommodate large deformations as it is not a supporting element for the tool 100, but only a heat-transfer element. In other word, the tool 100 is supported inside the well 902 by a corresponding casing 910, which may include plural casing elements connected to each other, as illustrated in FIG. 9B. A casing element may have a length of about 12 m. The tool 100 may have a similar or smaller length. The plural casing elements may be connected to each other by threads, as is known in the art. The tool 100 may be connected with threads to the lower end of the last casing element.

The high thermal conductivity of the alloys at high temperature allows the heat transfer from the metal shoe 130 to the co-axial pipes 110/120. Thermo-hydraulic numerical simulations are run to optimize the design of the tool and the corresponding well (shoe length and diameter, well diameter, number and position of co-axial-well-with-shoe systems).

FIG. 9A shows a surface casing 904 and a sacrificial casing 906 installed in well 902 drilled with a drill string 908. Note that both casings are installed above the SHR. The drill string 908 may have a drill tip 909 for drilling well 902. A rotary table 912 installed at the surface of the well is used for driving the drill tip. When the well is ready, the drill tip 909 and the drill string 908 are removed and the tool 100 is lowered into the well, as shown in FIG. 9B. To align the tool 100 with the longitudinal axis of the well 902, a centralizer 914 may be installed over the tool 100, as shown in the figure. In one embodiment, to prevent the fluid from the SHR to enter the casing 906, a packer 916 may be installed, for example, just above the shoe 130, as shown in FIG. 9B. For safety issues, to prevent the violent release of the fluid from the well 902 or the casing 910 to the surface, a blowout preventer 918 may be installed on the head of the well. A blowout preventer 918 is essentially a powerful valve that is configured to close (seal) the well if a pressure inside the well becomes larger than a given pressure. In one application, the annulus between the sacrificial casing 906 and the co-axial tool 100 is filled by adapted viscous gel that ensures the thermal insulation of the heat extraction tool, while limiting the thermal stress on the sacrificial casing and its cement.

After the heat from the SHR has been extracted in step 1006, which can take months if not years, the casing 910 and associated tool 100 are removed from the well in step 1008 and the well 902 is sealed with cement plugs 920 in step 1010, as illustrated in FIG. 9C. In this way, there is little chance that any fluid from the well can escape to the surface after the well is abandoned. Abandonment would occur when, after a certain amount of time depending on the SHR origin, the heat at the shoe will not be enough to be economically extracted, and the co-axial tool with the shoe might be removed if such a design has been chosen. Abandonment design would consider the predicted effective duration of the heat source, which could be a coal or peat fire, underground coal gasification, or a thin magmatic dike or sill.

Smart and safe implementation of this technology may be matched with monitoring methods, for example, focusing in particular on the temperature, the pressure, and the mechanical behaviour of the tool and of the hosting rock-mass. Additional specific monitoring may be required depending on the nature of the SHR. For example, distributed acoustic sensing (DAS) systems 903 cemented behind the sacrificial casing 906 would allow monitoring of the temperature and the pressure at the interface between the rock-mass and the tool, while DAS fibres inserted in the coaxial tool 100 and fixed to the inner or outer tube give temperature and pressure evolution with the depth in the co-axial loop. In one application, seismic sensors network 930 at the surface (or buried in noisy environments), as schematically illustrated in FIG. 9A, offer an additional system to detect and locate the potential creation or shearing of faults and fractures due to induced thermal stress. This network can also be used to determine the location of the SHR and to ensure that only the shoe 130 enters into the SHR, and not the inner and outer pipes.

The term “about” is used in this application to mean a variation of up to 20% of the parameter characterized by this term. It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a co-axial tool with an end shoe that is used for extracting heat from a reservoir that exhibits one or more extreme parameters, like high temperature. By placing only the shoe of the tool in the reservoir, the other components of the tool are partially protected (insulated) from the high temperature. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Frioleifsson G. O., Pálsson B., Albertsson A. L., Stefánsson B., Gunnlaugsson E., Ketilsson J., Gíslason P., 2015, IDDP-1 Drilled Into Magma—World's First Magma-EGS System Created, Proceedings World Geothermal Congress 2015, Melbourne, Australia, 19-25 Apr. 2015;
[2] Kačur, J. and Kostúr, K. (2017). Approaches to the gas control in UCG. Acta Polytechnica, 57(3), pp.182-200. doi.org/10.14311/ap.2017.57.0182.
[3] Otto, C., Kempka, T., Kapusta, K. and Stańczyk, K. (2016). Fault Reactivation Can Generate Hydraulic Short Circuits in Underground Coal Gasification—New Insights from Regional-Scale Thermo-Mechanical 3D Modeling. Minerals, 6(4), pp. 101-119. doi.org/10.3390/min6040101.
[4] Bhutto, A. W., Bazmi, A. A. and Zahedi, G. (2013). Underground coal gasification: From fundamentals to applications. Progress in Energy and Combustion Science, 39, pp. 189-214. doi.org/10.1016/j.pecs.2012.09.004.
[5] Horne, R. N. (1980). Design considerations of a down-hole coaxial geothermal heat exchanger. In: Geothermal Resource Council Transactions, Volume 4. Salt Lake City, 9 Sep. 1980.
[6] International Patent Application Publication WO 2017/103950.
[7] International Patent Application Publication WO 2020/084642A1.

1. A tool for extracting heat from a reservoir, the tool comprising:
a shoe made of a material that withstands temperatures larger than 500° C.;
an outer pipe attached to the shoe;
an inner pipe located within the outer pipe and forming an annulus with the outer pipe, the inner pipe having a bore; and
a flexible connection configured to connect the outer pipe to the shoe so that the outer pipe is allowed to extend and contract without leaking a fluid inside the annulus,
wherein the inner pipe and the outer pipe are configured to form an uninterrupted loop path for the fluid, between a top of the annulus and a top of the bore while also allowing the fluid to directly contact the shoe.

2. The tool of claim 1, further comprising:
a strainer element located between the inner pipe and the shoe along a longitudinal axis; and
an additional flexible connection between the inner pipe and the strainer element, wherein the loop path extends from the annulus to the bore through plural holes formed in the strainer element.

3. The tool of claim 2, wherein the strainer element is integral part of the shoe.

4. The tool of claim 1, wherein the inner pipe is directly attached to the shoe with an additional flexible connection.

5. The tool of claim 4, wherein the inner tube includes plural holes so that the loop path extends from the annulus to the bore through the plural holes.

6. The tool of claim 1, further comprising:
a lug that fixedly attaches the inner pipe relative to the outer pipe so that a bottom end of the inner pipe floats above the shoe to allow the loop path to leave the annulus and enter the bore.

7. The tool of claim 1, wherein the inner pipe is directly connected to the shoe with an additional flexible connection, and the shoe has one or more channels that allow the loop path to extend from the annulus to the bore through the one or more channels.

8. The tool of claim 7, wherein the one or more channels are formed exclusively into a body of the shoe.

9. The tool of claim 1, wherein the shoe includes only a solid body with no other component.

10. The tool of claim 1, wherein the inner and outer pipes are concentric.

11. The tool of claim 1, wherein the shoe is shaped as a cone and the shoe has a helix attached to an external surface of the cone, or the shoe is shaped as a cylinder having a distal toe.

12. A heat extraction system for extracting heat from a reservoir, the heat extraction system comprising:
a casing element configured to be lowered into a well or driven into the ground; and
a tool configured to be attached to a distal end of the casing element, wherein the tool includes,
a shoe made of a material that withstands temperatures larger than 500° C.;
an outer pipe attached to the shoe;
an inner pipe concentrically located within the outer pipe and forming an annulus with the outer pipe, the inner pipe having a bore; and
a flexible connection configured to connect the outer pipe to the shoe so that the outer pipe is allowed to extend and contract without leaking a fluid ) inside the annulus,
wherein the inner pipe and the outer pipe are configured to form an uninterrupted loop path for the fluid, between a top of the annulus and a top of the bore while also allowing the fluid to directly contact the shoe.

13. The heat extraction system of claim 12, further comprising:
a centralizer configured to centralize the casing element within the well; and
a packer configured to stop a fluid from the well to advance toward an upper part of the tool.

14. The heat extraction system of claim 12, wherein the tool further comprises:
a strainer element located between the inner pipe and the shoe along a longitudinal axis; and
an additional flexible connection between the inner pipe and the strainer element,
wherein the loop path extends from the annulus to the bore through plural holes formed in the strainer element.

15. The heat extraction system of claim 14, wherein the strainer element is an integral part of the shoe.

16. The heat extraction system of claim 12, wherein the inner pipe is directly attached to the shoe with an additional flexible connection, and wherein the inner tube includes plural holes so that the loop path extends from the annulus to the bore through the plural holes.

17. The heat extraction system of claim 12, wherein the tool further comprises:
a lug that fixedly attaches the inner pipe relative to the outer pipe so that a bottom end of the inner pipe floats above the shoe to allow the loop path to leave the annulus and enter the bore.

18. The heat extraction system of claim 12, wherein the inner pipe is directly connected to the shoe with an additional flexible connection, and the shoe has one or more channels that allow the loop path to extend from the annuls to the bore through the one or more channels.

19. The heat extraction system of claim 18, wherein the one or more channels are formed exclusively into a body of the shoe.

20. The heat extraction system of claim 12, wherein the shoe is shaped as a cone or as a cylinder having a distal toe.
